(19) United States
(12) Patent Application Publication
(10) Pub. No.: US 2008/0268803 A1
(43) Pub. Date: Oct. 30, 2008

(54) Techniques for antenna retuning utilizing receive power information

(76) Inventor: Guillaume Blin, Malden, MA (US)

Correspondence Address: LAW OFFICE OF WILLIAM J. TUCKER, 2631 Lakeforest Ct., Dallas, TX, 75214, US

(21) Appl. No.: 11/789,751

(22) Filed: Apr. 25, 2007

(51) Int. Cl. H04B 1/18

(52) U.S. Cl. 455/193.1

(57) ABSTRACT

An embodiment of the present invention provides a method, comprising using a received signal strength indicator (RSSI) to acquire information about received power in a receiver and using the received power information to tune an antenna tuner connected to the receiver.

### BACKGROUND OF THE INVENTION

Wireless devices have become prevalent throughout society. As users demand more mobility, there is a tremendous requirement for decreasing power consumption and thereby increasing battery life. Further, many wireless devices may transmit on a plurality of carrier frequencies and include circuits dealing with several frequency bands of operation and may receive and transmit at varying power levels. In wireless applications, the transmitted power is much higher than the received power and to perform the retuning of a mismatched antenna or matching network, power measurement must be performed.

Thus, there is a strong need for techniques for antenna retuning utilizing receive power information.

### SUMMARY OF THE INVENTION

An embodiment of the present invention provides a method, comprising using a received signal strength indicator (RSSI) to acquire information about received power in a receiver and using the received power information to tune an antenna tuner connected to said receiver.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates an apparatus adapted for receive power measurements and antenna retuning of an embodiment of the present invention;

FIG. 2 illustrates a first apparatus adapted for closed loop receive power measurements and antenna retuning of an embodiment of the present invention;

FIG. 3 illustrates a second apparatus adapted for closed loop receive power measurements and antenna retuning of an embodiment of the present invention;

FIG. 4 illustrates a method according to one embodiment of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

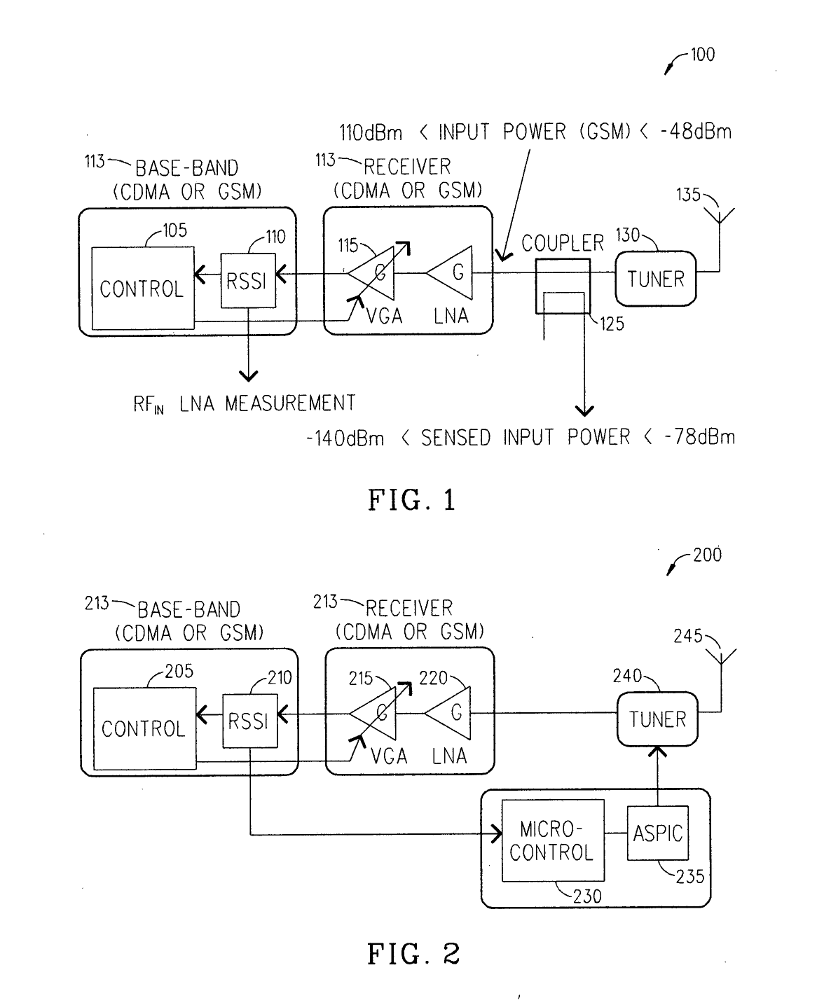

Looking now at FIG. 1 is an embodiment of the present invention which provides an apparatus 100 adapted for receive power measurements and antenna retuning comprising a receiver 113, an antenna tuner 130 associated with the receiver 113, a power detector 110 adapted to acquire information about received power, and wherein the antenna tuner 130 is tuned based upon the received power information. In an embodiment of the present invention, the received power may be measured by a base band received signal strength indicator (RSSI) 110. The receiver may further comprise a variable gain amplifier (VGA) 115 in communication with a baseband controller 105 via a RSSI 110. The apparatus 100 may further comprise a coupler coupling the receiver 113 with the antenna tuner 130 (connected to antenna 135) and provided sensed input power information. In a further embodiment of the present invention, the receiver may further comprise a low noise amplifier 120 receiving signals from the antenna tuner 130 via the coupler 125 and passing amplified signals to the variable gain amplifier (VGA) 115. The RSSI may provide the controller with RF input measurements and the coupler 125 may sense input power and the antenna may be tuned by using voltage tunable dielectric capacitors—although the present invention is not limited in this respect.

Turning now to FIG. 2 is an apparatus 200 adapted for closed loop receive power measurements and antenna retuning of an embodiment of the present invention, wherein the receiver 213 may further comprise a low noise amplifier 220 receiving signals from an antenna tuner 240 and passing amplified signals to a variable gain amplifier (VGA) 215 which outputs to a RSSI 210 to a base-band controller 205 and also via the RSSI to a micro-controller 230 which outputs to an application specific programmable integrated circuit (ASPIC) 235 controlling the antenna tuner 240 to enable antenna 245 tuning. Again, tuning may be accomplished utilizing voltage tunable dielectric capacitors, as an example.

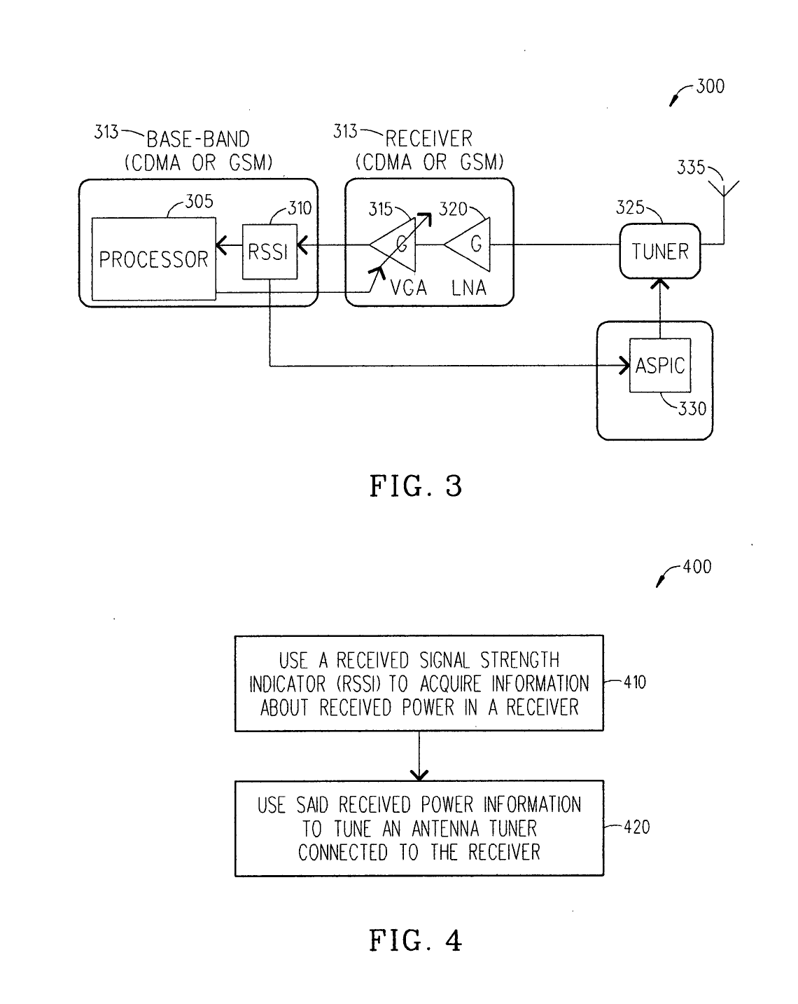

Turning now to FIG. 3 is an apparatus 300 adapted for closed loop receive power measurements and antenna retuning of an embodiment of the present invention, wherein the receiver 313 may further comprises a low noise amplifier 320 receiving signals from an antenna tuner 325 and passing amplified signals to a variable gain amplifier (VGA) 315 which outputs an RSSI 310 to a processor 305, the processor 305 communicating with an application specific programmable integrated (ASPIC) circuit 330 controlling the antenna tuner 325 to enable antenna 335 tuning. In an embodiment of the present invention the apparatus 100, 200 or 300 may provided the antenna tuner be tuned by using voltage tunable dielectric capacitors.

Turning now to FIG. 4, shown generally as 400, is provided a method of an embodiment of the present invention comprising using a received signal strength indicator (RSSI) to acquire information about received power in a receiver 410, and using the received power information to tune an antenna tuner connected to the receiver 420. The present method may further comprise using a variable gain amplifier (VGA) in communication with a baseband controller via a RSSI and using a coupler coupling the receiver with the antenna tuner to sense input power information. The present method may also further comprise using a low noise amplifier which receives signals from the antenna tuner via the coupler and pass amplified signals to the variable gain amplifier (VGA) and wherein the RSSI provides the controller with RF input measurement and the coupler senses input power. The receiver may use a low noise amplifier to receive signals from an antenna tuner and pass amplified signals to a variable gain amplifier (VGA) which outputs an RSSI to a processor, the processor communicating with an application specific programmable integrated (ASPIC) circuit controlling the antenna tuner to enable antenna tuning.

Still another embodiment of the present method provides that the receiver may use a low noise amplifier to receive signals from an antenna tuner and pass amplified signals to a variable gain amplifier (VGA) which outputs an RSSI to a processor and a micro-controller which outputs to an application specific programmable integrated. (ASPIC) circuit controlling the antenna tuner to enable antenna tuning.

Some embodiments of the present invention may be implemented, for example, using a machine-readable medium or article which may store an instruction or a set of instructions that, if executed by a machine, for example, by the apparatus of FIGS. 1, 2 or 3, by the processor, micro-controller or ASPIC or by other suitable machines, cause the machine to. perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

In an embodiment of the present invention the machine-accessible medium that provides instructions, which when accessed, may cause the machine to perform operations comprising using a received signal strength indicator (RSSI) to acquire information about received power in a receiver and using the received power information to tune an antenna tuner connected to the receiver. The machine-accessible medium of an embodiment of the present invention may further comprise the instructions causing the machine to perform operations further comprising using a variable gain amplifier (VGA) in communication with a baseband controller via a RSSI and using a coupler coupling the receiver with the antenna tuner to sensed input power information.

The machine-accessible medium may further comprise the instructions causing the machine to perform operations further comprising the receiver using a low noise amplifier to receive signals from an antenna tuner and passing amplified signals to a variable gain amplifier (VGA) which outputs an RSSI to a processor, the processor communicating with an application specific programmable integrated (ASPIC) circuit controlling the antenna tuner to enable antenna tuning. Also, the machine-accessible medium may further comprise the instructions causing the machine to perform operations further comprising the receiver using a low noise amplifier to receive signals from an antenna tuner and passing amplified signals to a variable gain amplifier (VGA) which outputs an RSSI to a processor and a micro-controller which outputs to an application specific programmable integrated (ASPIC) circuit controlling the antenna tuner to enable antenna tuning.

Some embodiments of the present invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Regarding the timing for retuning, in an embodiment of the present invention the antenna retuning may occur once per frame, before the burst. In this case, power is measured and averaged on the previous burst, the calculation of next biasing points is performed and new values are applied for the following burst. This has the advantages of a lot of time to compute, power savings, no transients issues (spurious), and is fast enough for humans (−100 ms for retuning).

While the present invention has been described in terms of what are at present believed to be its preferred embodiments, those skilled in the art will recognize that various modifications to the disclose embodiments can be made without departing from the scope of the invention as defined by the following claims.

What is claimed is:

1. An apparatus, comprising:
a receiver;
an antenna tuner associated with said receiver;
a power detector adapted to acquire information about received power; and
wherein said antenna tuner is tuned based upon said received power information.

2. The apparatus of claim 1, wherein said received power is measured by a base band received signal strength indicator (RSSI).

3. The apparatus of claim 2, wherein said receiver further comprises variable gain amplifier (VGA) in communication with a baseband controller via a RSSI.

4. The apparatus of claim 3, further comprising a coupler coupling said receiver with said antenna tuner and provided sensed input power information.

5. The apparatus of claim 4, wherein said receiver further comprises a low noise amplifier receiving signals from said antenna tuner via said coupler and passing amplified signals to said variable gain amplifier (VGA).

6. The apparatus of claim 5, wherein said RSSI provides said controller with RF input measurement and said coupler senses input power.

7. The apparatus of claim 2, wherein said receiver further comprises a low noise amplifier receiving signals from an antenna tuner and passing amplified signals to a variable gain amplifier (VGA) which outputs an RSSI to a processor, said processor communicating with an application specific programmable integrated (ASPIC) circuit controlling said antenna tuner to enable antenna tuning.

8. The apparatus of claim 2, wherein said receiver further comprises a low noise amplifier receiving signals from an antenna tuner and passing amplified signals to a variable gain amplifier (VGA) which outputs an RSSI to a processor and a micro-controller which outputs to an application specific programmable integrated (ASPIC) circuit controlling said antenna tuner to enable antenna tuning.

7. The apparatus of claim 1, wherein said antenna tuner is tuned by using voltage tunable dielectric capacitors.

8. A method, comprising:
using a received signal strength indicator (RSSI) to acquire information about received power in a receiver; and
using said received power information to tune an antenna tuner connected to said receiver.

9. The method of claim 8, further comprising using a variable gain amplifier (VGA) in communication with a baseband controller via a RSSI.

10. The method of claim 9, further comprising using a coupler coupling said receiver with said antenna tuner to sensed input power information.

11. The method of claim 10, further comprising using a low noise amplifier which receives signals from said antenna tuner via said coupler and passes amplified signals to said variable gain amplifier (VGA).

12. The method of claim 11, wherein said RSSI provides said controller with RF input measurement and said coupler senses input power.

13. The method of claim 9, further comprising said receiver using a low noise amplifier to receive signals from an antenna tuner and passing amplified signals to a variable gain amplifier (VGA) which outputs an RSSI to a processor, said processor communicating with an application specific programmable integrated (ASPIC) circuit controlling said antenna tuner to enable antenna tuning.

14. The method of claim 9, further comprising said receiver using a low noise amplifier to receive signals from an antenna tuner and passing amplified signals to a variable gain amplifier (VGA) which outputs an RSSI to a processor and a micro-controller which outputs to an application specific programmable integrated (ASPCIC) circuit controlling said antenna tuner to enable antenna tuning.

15. A machine-accessible medium that provides instructions, which when accessed, cause a machine to perform operations comprising:
using a received signal strength indicator (RSSI) to acquire information about received power in a receiver; and using said received power information to tune an antenna tuner connected to said receiver.

16. The machine-accessible medium of claim 13, further comprising said instructions causing said machine to perform operations further comprising using a variable gain amplifier (VGA) in communication with a baseband controller via a RSSI.

17. The machine-accessible medium of claim 14, further comprising said instructions causing said machine to perform operations further comprising using a coupler coupling said receiver with said antenna tuner to sensed input power information.

18. The machine-accessible medium of claim 15, further comprising said instructions causing said machine to perform operations further comprising using a low noise amplifier which receives signals from said antenna tuner via said coupler and passes amplified signals to said variable gain amplifier (VGA).

19. The machine-accessible medium of claim 16, wherein said RSSI provides said controller with RF input measurement and said coupler senses input power.

20. The machine-accessible medium of claim. 15, further comprising said instructions causing said machine to perform operations further comprising said receiver using a low noise amplifier to receive signals from an antenna tuner and passing amplified signals to a variable gain amplifier (VGA) which outputs an RSSI to a processor, said processor communicating with an application specific programmable integrated (ASPIC) circuit controlling said antenna tuner to enable antenna tuning.

21. The machine-accessible medium of claim 15, further comprising said instructions causing said machine to perform operations further comprising said receiver using a low noise amplifier to receive signals from an antenna tuner and passing amplified signals to a variable gain amplifier (VGA) which outputs an RSSI to a processor and a micro-controller which outputs to an application specific programmable integrated (ASPIC) circuit controlling said antenna tuner to enable antenna tuning.
